(19) United States
(12) Patent Application Publication
(10) Pub. No.: US 2010/0175012 A1
(43) Pub. Date: Jul. 8, 2010

(54) System and Method for Remote Monitoring and Control of Field Device

(76) Inventors: Peter E. Allstrom, Attleboro, MA (US); David A. Ferreira, Hope, RI (US)

Correspondence Address: Richard L. Sampson;SAMPSON & ASSOCIATES. P.C., 50 Congress Street, Boston, MA, 02109, US

(21) Appl. No.: 12/349,170

(22) Filed: Jan. 6, 2009

(51) Int. Cl. G06F 3/048

(52) U.S. Cl. 715/771

(57) ABSTRACT

A system and method for remotely monitoring a field device includes a console communicably coupled to a field device located remotely therefrom. The console is configured to capture output data from an output buffer of one or more field devices, in which the output buffer is also configured to supply said output data to a field device user interface. The console displays a representation of the field device user interface, and displays the captured output data on the representation in substantially the same manner as displayed on the field device user interface.

### BACKGROUND

1. Technical Field

This invention relates to field device monitoring and control, and more particularly to a remote virtual representation of a field device output, and remote control of the field device.

2. Background Information

Industrial control networks typically include field devices which control local operations such as gathering data from sensor systems, and monitoring the local site for error conditions. A field device may also transmit error conditions and alarms to the control station.

In some networks, field devices may be configured from control stations. Configuration options include how the display looks, which measurement to display, and the number of decimal places of the displayed measurement. However, in order to determine whether the configurations have been appropriately implemented on the field devices, it is typically necessary to physically check the field device user interface, such as the front panel display. If the field device is located on a site remote from the control station, then it may be necessary to travel to the field device site in order to check the settings. Otherwise, the person in the control station may have to attempt to interpret data to determine what the configuration settings look like, which tends to be awkward and counterintuitive.

Control stations may also be used to detect error conditions. In order to detect the source of the problem, diagnostic tests may be used. Diagnostic tests often involve testing various settings on a field device in an attempt to pinpoint the problem. A drawback to using a control station to run diagnostics is that the settings on the field device may have to be manually reset, i.e., at the site of the field device, requiring travel to the remote transmitter location. So, even if the problem can be identified at the control station, a technician may be required to travel to the site of the field device in order to clear or otherwise rectify the condition using the field device's front panel.

These drawbacks tend to be exacerbated for relatively large, distributed networks in which field devices may be located as far away as a mile or more from the control station. In these situations, an undesirably large investment of time and resources would be required to travel to each of the remote field devices to check configuration settings or to adequately respond to an alarm.

Thus, a need exists for a system which allows a user to observe the display of a field device from a console located remotely therefrom, and optionally to control the field device from the console.

### SUMMARY

In one aspect of the invention, a system for remotely monitoring a field device includes a console communicably coupled to a field device located remotely therefrom. The console captures output data from an output buffer of the field device, in which the output buffer is also configured to supply the output data to a field device user interface. The console displays a representation of the field device user interface, including the captured output data in substantially the same manner as displayed by the field device user interface. The console is also configured to receive user input via the representation, and to transmit instructions corresponding to the user input to an input buffer of the field device, in which the input buffer is also configured to capture user input from the field device user interface. The field device is configured to receive and execute the instructions in substantially the same manner as input from the field device user interface.

In another aspect of the invention, a system for remotely monitoring a field device includes a console communicably coupled to a field device located remotely therefrom. The console is configured to capture output data from an output buffer of one or more field devices, in which the output buffer is also configured to supply said output data to a field device user interface. The console is also configured to display a representation of the field device user interface, and to display the captured output data on the representation in substantially the same manner as displayed on the field device user interface.

In still another aspect of the invention, a method of providing a system for monitoring a field device from a remote console, includes configuring a console for being communicably coupled to a remote field device, configuring the console to obtain data from an output buffer on the field device, and configuring the console to represent the output buffer data on a display in the console.

In yet another aspect of the invention, a method for remotely monitoring a field device includes communicably coupling a monitoring console to a field device located remotely therefrom, and capturing, with the monitoring console, output data from an output buffer of the field device, in which the output buffer is also configured to supply the output data to a field device user interface. The method also includes displaying, with the monitoring console, a representation of the field device user interface, and displaying, with the monitoring console, the captured output data on the representation in substantially the same manner as displayed on the field device user interface.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a block diagram of an embodiment of the subject invention;

FIG. 2 is a block diagram of an alternate embodiment of the subject invention;

FIG. 3 is a block diagram of yet another embodiment of the subject invention;

FIG. 4A is a perspective view of an exemplary field device used in embodiments of the subject invention;

FIG. 4B is a screenshot of a console usable with the field device of FIG. 4A; and

FIG. 5 is a flowchart of a method associated with an embodiment of the subject invention.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings shall be indicated with like reference numerals and similar features as shown in alternate embodiments in the drawings shall be indicated with similar reference numerals.

Briefly, embodiments of the claimed invention allow a user to monitor and control a field device from a location remote from the field device. The field device display and, in some embodiments, the entire field device user interface (e.g., the field device front panel) is represented on a remote console display. The console is communicably coupled to the field device, and is configured to obtain data from an output buffer on the field device. This output buffer data, which is configured for display on the field device user interface, is thus also adapted for display on the console.

A user may then view the data retrieved from the field device, as displayed on the console. While the representation of the data on the console user interface may differ slightly from the representation of the same data on the field device display, the substance of the data is substantially identical.

In particular embodiments, an end user is able to control the field device through a console user interface. In such embodiments, the console is configured for transmission of instructions to the field device, and the field device is configured to receive and execute these instructions. This allows a user to effectively control the field device remotely, and to monitor the results through the console display.

It should be noted that the various elements shown in some embodiments, such as memory 50, and the generation of information requests 14 to effectively pull information from the field device, may be used in any of the various embodiments of the invention, even if not shown or described with respect thereto.

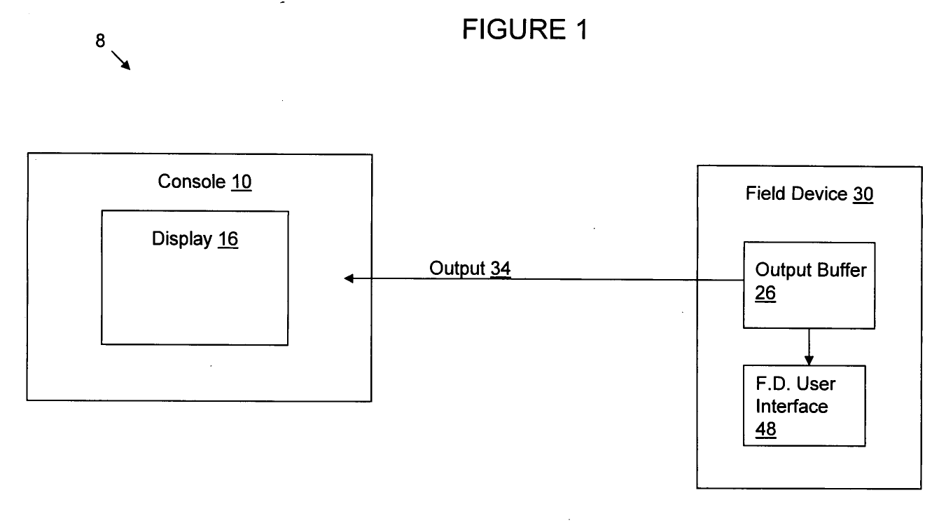

Referring now to the Figures, various embodiments of the present invention will be described in detail. Turning to FIG. 1, in one embodiment, system 8 includes a console 10 having a console display 16, which is communicably coupled to a field device 30 having an output buffer 26 and field device user interface 48. Console 10, which is located remotely from the site of the field device 30, is typically a computer, such as a personal computer, a work station, a control station, a hand held smart device (e.g., personal digital assistant of smart phone), or substantially any device having at least a processor, a computer usable medium on which computer readable instructions (including data) may be stored, and a user interface. Field device 30 is also typically a “smart” device or dedicated-use computer, having a processor, a computer usable medium on which computer readable instructions (including data) may be stored, and a user interface. Examples of commercially available field devices which may be used in connection with the present invention, include the Invensys® I/A Series Model Foxboro 84 and 87X instruments available from Invensys Systems, Inc., Foxborough, Mass.

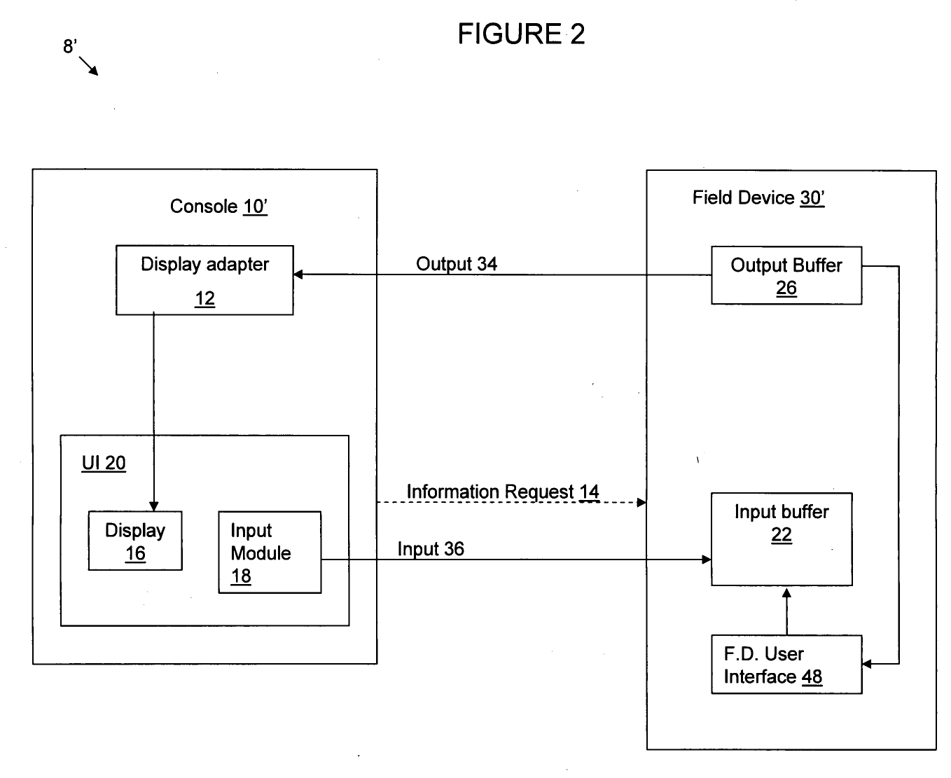

During operation of field device 30, data intended for display by user interface 48 is supplied to output buffer 26 in a conventional manner. This data, referred to herein as output buffer data 34, is then fed in a conventional manner to field device user interface 48 for display. In accordance with the teachings of the present invention, this same output buffer data 34 is also forwarded or transmitted from output buffer 26 to console 10. In this regard, it should be noted that embodiments of the subject invention may use conventional “pull” technology to obtain the output buffer data 34, e.g., in which the console 10 (and/or 10′, 10″ as discussed hereinbelow) sends an instruction 14 (FIG. 2), such as a read request, to the field device 30, prompting the field device to send the requested data to console 10. Alternatively, “push” technology may be used, in which field device 30 automatically transmits data to console 10, e.g., at predetermined intervals or upon predetermined events, without requiring an information request. The embodiments disclosed herein may also use a combination of “push” and “pull” technology.

The console 10 is configured to receive the data 34, and to display the data 34 on its console display 16, which is configured as a representation (e.g., a virtual representation) of the user interface 48. An end user may thus view, on the console display 16, a virtual representation of the field device user interface 48. In this regard, the console display 16 may be configured to represent various physical aspects of the field device user interface 48. For example, physical input buttons from a front panel of a field device may be represented by virtual facsimiles thereof, on the console display 16, as will be described in greater detail hereinbelow.

In various embodiments, a conventional industrial process network is used for the transfer of the output data from the field device output buffer to the console. Embodiments may thus be compatible with various client systems, such as conventional supervisory control and data acquisition systems, and distributed control systems. This compatibility allows these embodiments to communicate with control and measurement equipment from these various systems. For example, the output data may be transmitted via wired connection using a fieldbus communications protocol. Alternatively, the output data may be transmitted wirelessly from the field device to the console module. Examples of suitable protocols include FoxCom, HART, Foundation Field Bus, Modbus, Profibus, Zigbee™ (IEEE 802.15.4), DeviceNet, ControlNet, Ethernet/IP, DH+, Intranet, SEELBUS, and combinations thereof.

Turning now to FIG. 2, system 8′ is substantially similar to system 8, while including the following additional aspects. As shown, console 10′ is optionally configured for sending an information request 14 to field device 30′, to pull the output buffer data 34 as discussed above. Alternatively, the buffer data 34 may be pushed as also discussed. As shown, console 10′ includes a display adapter 12, which is configured to receive and adapt the output buffer data 34 for display on the virtual representation of console display 16. As also shown, display 16 is a component of console user interface 20, which also includes user input module 18. Input module 18 operates in a conventional manner, and may include substantially any number or types of user input devices, including keyboards, touch screens, mice, joysticks, IR, RF, or voice-activated input devices, etc., which allows a user to input instructions to the console, as described below.

In operation, an end user may control the field device 30′ by manipulating input module 18 of console 10′. For example, module 18 may be used to generate a virtual button on console display 16, which represents a physical button on a front panel of the field device 30′, as will be described in more detail hereinbelow. By pushing, clicking on, or otherwise actuating one of the virtual buttons, a user may effectively send instructions 36 from the console 10′ to the field device 30′, where they are received by input buffer 22. Once received by buffer 22, the instructions 36 are processed by field device 30′ in substantially the same manner as if the instructions had been sent to buffer 22 from the local user interface 48.

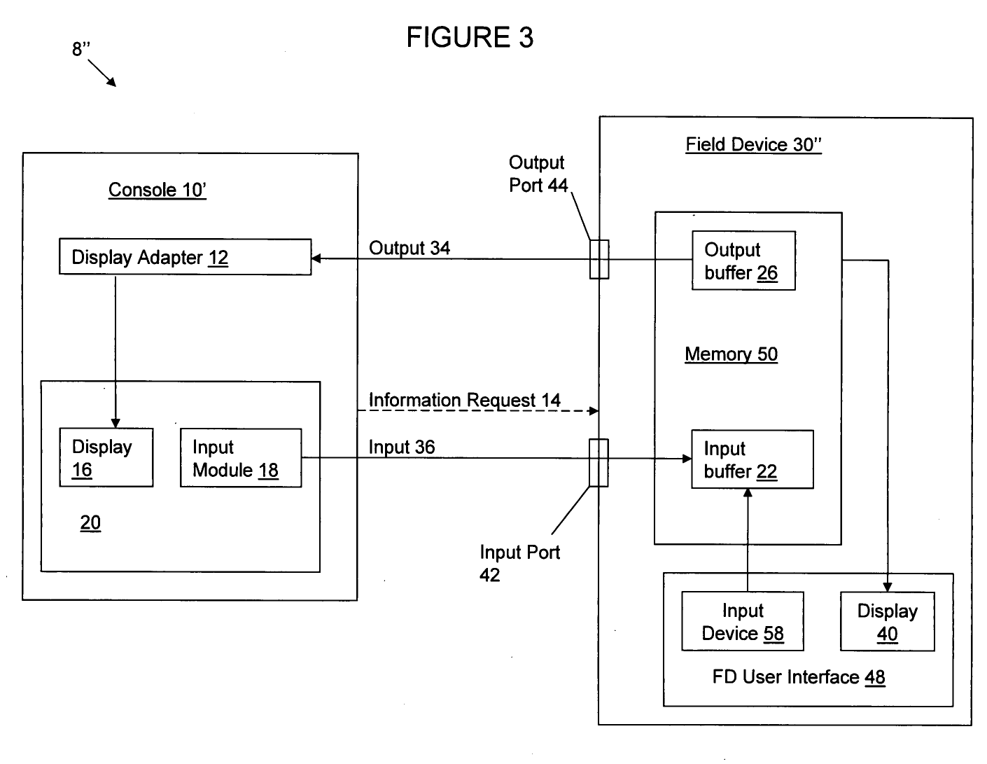

Turning now to FIG. 3, system 8″ is similar to systems 8, 8′ in many respects. As shown, input and output buffers 22, 26 are disposed within computer readable media (e.g., memory) 50 of field device 30″. Also, user interface 48 in this embodiment includes both an input device 58 (which may be similar to input module 18 of the console) and a display 40. Output data 34, e.g., in the form of status data collected by the field device including measurements and alarm conditions, may thus be forwarded from output buffer 26 to field display 40 for display to a local user. Moreover, input and output ports 42, 44 are shown, through which input and output 36, 34 are communicated.

Signals generated by input device 58 (which may include signals generated by display 40, e.g., when operating as a touch-screen) are fed to input buffer 22, for processing as discussed hereinabove.

Those skilled in the art will recognize that the various components described hereinabove may implemented in hardware, software disposed on a computer readable medium such as memory 50, or combinations thereof, without departing from the scope of the present invention.

Advantageously, embodiments of the invention allow the user to see, on a console display, a representation of the same data shown on the field device display. In this regard, although in many embodiments the representation is substantially identical to the field device display, it should be recognized that the manner in which information is displayed on console display 16 may differ from that of the field device, while displaying substantially the same information.

An added advantage to systems 8′ and 8″ is that the user may control field device 30′, 30″ through console 10′. Systems 8′, 8″ enable the field device input buffer 22 to process instructions 36 (transmitted from the console), as if they were entered through field device input buffer 22. Therefore, a user is able to control the field device 30′, 30″ from the console user interface 20, in a similar fashion to the way a user may control the field device user interface 48. This is because the instructions 36 transmitted from console 10′, 10″ are placed in the same place in the field device memory (e.g., input buffer 22), as instructions entered through the field device user interface 48, such as a front panel touch screen or keyboard. The instructions 36 may then be executed by the field device in a conventional manner.

The user thus may also use the console 10′ to view feedback from the inputted instructions 36. As discussed above, the field device output buffer 26 may include status data regarding the current conditions at the field device. This status data may reflect the effect on the field device of the inputted instructions 36. This status data may be displayed on console display 16, e.g., to confirm that the field device had executed the forwarded instructions, and providing information as to effects of these instructions on the field device.

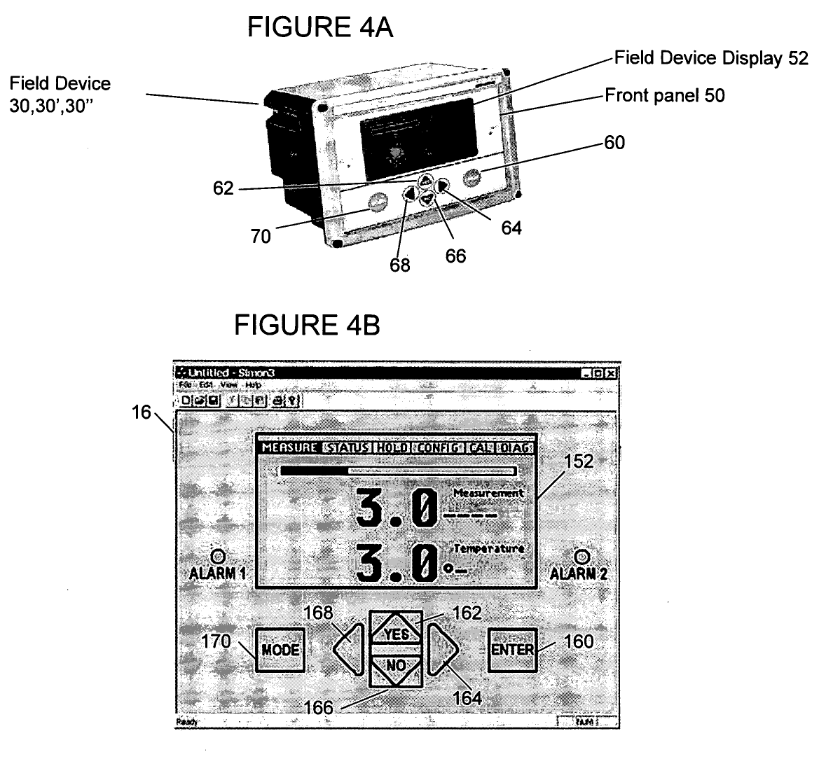

Turning now to FIGS. 4A-4B, exemplary user interfaces of both a field device (30, 30′, 30″) and the representation shown on display 16 of the aforementioned embodiments are shown and described. As shown, display 16 (FIG. 4B) displays a representation of the user interface of field device 30, 30′, 30″ (FIG. 4A).

In this embodiment, front panel 50 of the field device includes display 52 and physical buttons 60-70. The buttons 60-70, including enter button 60, up/yes button 62, left button 68, down/no button 66, right button 64, and mode button 70, allow a user to control the display 52.

The physical interface of the field device of FIG. 4A is represented on console display 16 of FIG. 4B. Display 52 of the field device is depicted at 152, and enter button 60 is represented at 160. Buttons 62 to 70 are respectively shown at 162 to 170.

Although the physical buttons and virtual buttons serve similar functions, they may optionally have somewhat different appearances. A virtual button may have a different shape than its physical counterpart. Virtual buttons may also be disposed at somewhat different locations than their physical counterparts. For example, virtual buttons may be disposed adjacent to one another, even though their physical counterparts may be spaced apart, to facilitate physical pushing.

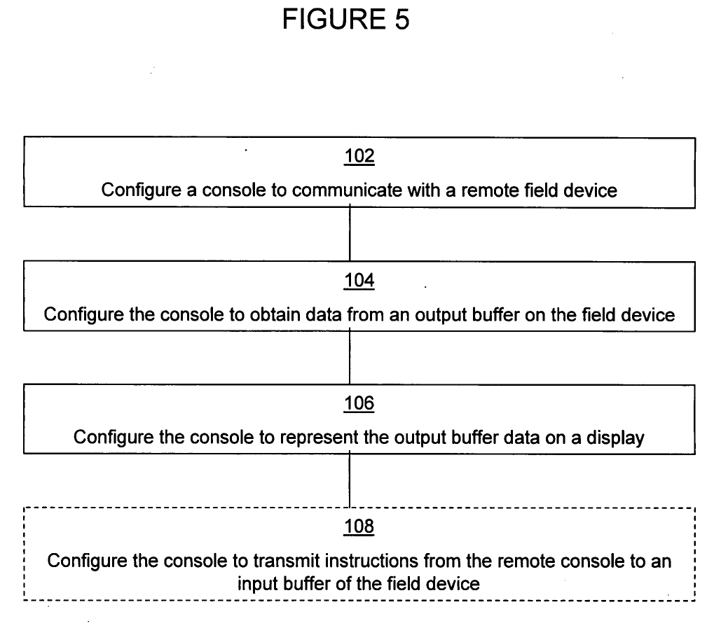

Turning to FIG. 5, a method in accordance with embodiments of the present invention is shown and described. At 102, a console is configured to communicate with a remote field device. At 104, the console is configured to access data from an output buffer on a field device. At 106, the console is configured to display the accessed data. Optionally, at 108, the console is configured to transmit user input instructions to an input buffer of the field device.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

It should be understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having thus described the invention, what is claimed is:

1. A system for remotely monitoring a field device, the system comprising:
a console communicably coupled to a field device located remotely therefrom;
said console being configured to capture output data from an output buffer of the field device, in which the output buffer is also configured to supply said output data to a field device user interface;
said console being configured to display a representation of the field device user interface;
said console being configured to display the captured output data on said representation in substantially the same manner as displayed by the field device user interface;
said console being configured to receive user input via said representation;
said console being configured to transmit instructions corresponding to said user input to an input buffer of the field device, in which the input buffer is also configured to capture user input from the field device user interface;
wherein the field device is configured to receive and execute the instructions in substantially the same manner as input from the field device user interface.

2. A system for remotely monitoring a field device, the system comprising:
a console communicably coupled to a field device located remotely therefrom;
said console being configured to capture output data from an output buffer of one or more field devices, in which the output buffer is also configured to supply said output data to a field device user interface;
said console being configured to display a representation of the field device user interface; and
said console being configured to display the captured output data on said representation in substantially the same manner as displayed on the field device user interface.

3. The system of claim 2, wherein said console is configured to receive user input via said representation.

4. The system of claim 3, wherein said console is configured to transmit instructions corresponding to said user input, to an input buffer of the field device, the input buffer also being configured to capture user input from the field device user interface, so that the field device is configured to receive and execute the instructions in substantially the same manner as input from the field device user interface.

5. The system of claim 2, wherein said representation is configured to represent physical aspects of the field device.

6. The system of claim 5, wherein said physical aspects comprise push buttons.

7. The system of claim 2, wherein the console comprises a console user interface, and said representation comprises a virtual representation displayed on said console user interface.

8. The system of claim 7, wherein said representation comprises computer readable program code disposed on computer usable media associated with said console.

9. The system of claim 2, wherein said console is configured to reformat the captured output data for display via said representation.

10. The system of claim 2, wherein said console is configured to communicate with the one or more field devices using a protocol selected from the group consisting of FoxCom, HART, Foundation Field Bus, Modbus, Profibus, Zigbee™ (IEEE 802.15.4), DeviceNet, ControlNet, Ethernet/IP, DH+, Intranet, SEELBUS, and combinations thereof.

11. The system of claim 2, comprising an analog network communicably coupling the console with the one or more field devices.

12. The system of claim 2, comprising a digital network communicably coupling the console with the one or more field devices.

13. The system of claim 2, wherein the captured output data comprises operational status information for the field device.

14. The system of claim 4, wherein said console is configured to remotely control the field device.

15. The system of claim 14, wherein said console is configured to control of the number of significant digits displayed on the field device.

16. The system of claim 15, wherein said console is configured to control of types of measurements performed by the field device.

17. The system of claim 2, wherein said console comprises a computer selected from the group consisting of: a personal computer; a work station; a control station; a hand held smart device; substantially any device having at least a processor, a computer usable medium on which computer readable instructions/data may be stored, and a user interface; and combinations thereof.

18. The system of claim 4, wherein said console is configured to receive output buffer data pushed by the field device.

19. The system of claim 4, wherein said console is configured to pull the output buffer data from the field device.

20. A method of manufacturing a system for monitoring a field device from a remote console, comprising:
configuring a console for being communicably coupled to a remote field device;
configuring said console to obtain data from an output buffer on the field device; and
configuring said console to represent the output buffer data on a display in the console.

21. The method of claim 20, comprising configuring said console to transmit instructions to the field device.

22. A method for remotely monitoring a field device, the method comprising:
(a) communicably coupling a monitoring console to a field device located remotely therefrom;
(b) capturing, with the monitoring console, output data from an output buffer of the field device, in which the output buffer is also configured to supply the output data to a field device user interface;
(c) displaying, with the monitoring console, a representation of the field device user interface; and
(d) displaying, with the monitoring console, the captured output data on the representation in substantially the same manner as displayed on the field device user interface.
